(19) United States
(12) Patent Application Publication
(10) Pub. No.: US 2016/0116273 A1
(43) Pub. Date: Apr. 28, 2016

(54) Method and Apparatus For Compensating Lift Elevation Induced Deviations In Vehicle Measurements

(71) Applicant: Hunter Engineering Company, St. Louis, MO (US)

(72) Inventors: David A. Voeller, St. Louis, MO (US); Timothy A. Strege, Sunset Hills, MO (US)

(21) Appl. No.: 14/920,181

(22) Filed: Oct. 22, 2015

Related U.S. Application Data
(60) Provisional application No. 62/069,125, filed on Oct. 27, 2014.

(51) Int. Cl. G01B 11/275; G01M 17/007

(52) U.S. Cl. CPC G01B 11/2755; G01M 17/007; G01B 2210/12

(57) ABSTRACT

A method and apparatus for enabling a vehicle wheel alignment measurement system to compensate one or more vehicle wheel alignment angles or vehicle body measurements acquired from a vehicle for changes associated with adjustments in the elevation of vertically movable runways of an automotive vehicle lift supporting the vehicle. An initial set of pose measurements are acquired with the movable runways at a stable first elevation. Following an elevation change to the movable runways, a second set of pose measurements are acquired with the movable runways at a second stable elevation. One or more compensation factors used to compensate vehicle wheel alignment angles or vehicle body measurements for changes in the automotive vehicle lift configuration are determined by a comparison of the initial and second sets of pose measurements.

### CROSS-REFERENCE TO RELATED APPLICATIONS

The present application is related to, and claims priority from, U.S. Provisional Patent Application Ser. No. 62/069,125 filed on Oct. 27, 2014, and which is herein incorporated by reference.

### STATEMENT REGARDING FEDERALLY SPONSORED RESEARCH

Not Applicable.

### BACKGROUND OF THE INVENTION

The present application relates to vehicle wheel alignment measurement systems used in conjunction with a vehicle support system configured to alter the elevation of a vehicle supporting surface, and in particular, to a machine-vision vehicle wheel alignment measurement system configured to establish compensation factors for changes in various vehicle measurements resulting from changes in the configuration of the vehicle supporting surface when moved between first and second elevations.

Vehicle wheel alignment measurement systems, as understood by one of ordinary skill in the art, typically consist of a set of sensors adapted to measure spatial position and rotational parameters (i.e., pose parameters) associated with the wheel assemblies or other components of a vehicle. The measured pose parameters are either directly or indirectly associated with traditional vehicle wheel alignment angles or vehicle body measurements, such as toe, camber, caster, steering axis inclination (SAI), ride height, thrust line, center line, or wheel runout. Determination of the traditional vehicle wheel alignment angles or vehicle body measurements is typically carried out by a processor configured with suitable software instructions to evaluate signals received from the set of sensors.

The sets of sensors utilized by vehicle wheel alignment measurement systems may include traditional angle transducers, gravity-referenced inclinometers, imaging sensors and associated optical targets, optical sensors and associated light emitters, as well as non-contact displacement measurement sensors in various arrangements and combinations. Vehicle wheel alignment measurement systems which are configured with imaging sensors to observe optical targets, to observe vehicle wheel assembly surfaces directly, or to acquire displacement measurements using reflected light, are commonly referred to as machine-vision vehicle wheel alignment systems, while vehicle wheel alignment measurement systems which are configured with angle transducers or gravity-referenced inclinometers are commonly referred to as traditional vehicle wheel alignment systems. The teachings of the present disclosure will be readily understood to be applicable to both machine-vision and traditional vehicle wheel alignment measurement systems, as well as to other systems such as, but not limited to, hybrid combinations of both types, or other systems capable of acquiring vehicle wheel alignment angle or vehicle body measurements not specifically mentioned herein.

Machine-vision vehicle wheel alignment systems typically use one or more imaging sensor arrays mounted away from a vehicle to obtain images of wheel-mounted optical targets or other identifiable features associated with a vehicle. Acquired images are processed to calculate some or all of the pose parameters for the observed optical targets or identifiable features observed in the images. Using some or all of the calculated pose parameters, various vehicle wheel alignment measurements may be determined using known mathematical techniques.

During a vehicle wheel alignment service procedure, it is common for a vehicle undergoing the service procedure to be positioned on an supporting surface such as a vehicle lift system (shown in FIGS. 1 and 2) to enable a technician to raise and lower the vehicle, as is required to access various components on the underside of the vehicle. Vehicle lift systems utilized during wheel alignment measurement procedures generally provide a pair of vertically adjustable runways on which the vehicle wheels are disposed. The runways may be either independent of each other, or coupled together with a connecting structure. Typically, each runway in a vehicle lift system is provided with one or more actuating mechanisms, such as a hydraulic cylinder or screw drive, and is controlled from a common location in order to regulate and coordinate the vertical elevation of the individual runways. For safety reasons, the control system which regulates the actuating mechanisms is generally configured to maintain each runway in a common horizontal plane during changes in elevation. Once an intended elevation is achieved by the runways, a safety or lock mechanism is engaged, preventing collapse of the vehicle lift system in the event of a failure in one or more of the actuating mechanisms.

When a vehicle is disposed on a vehicle lift system, and a machine-vision vehicle wheel alignment measurement system is employed, it is preferred, but not required, that the imaging sensors associated with the machine-vision vehicle wheel alignment system be connected to a suitable elevating or orientating mechanism so that the optical targets, vehicle wheel assemblies, or other observed vehicle features, remain within operative fields of view of the imaging sensors over the working range of elevation for the vehicle lift rack.

When the spatial relationships of the vehicle wheel alignment system imaging sensors and the vehicle supporting surface are altered, either through changes in elevation or changes in orientation, established or identified relationships between the various components can change. For example, the individual runways of a vehicle lift rack may be considered in an initial configuration when in a lowered elevation resting on the shop floor or in a recessed pit such as shown in FIG. 1, but may exhibit varying degrees of flex, twist, or localized distortion when raised to an elevated height, such as shown in FIG. 2, particularly when supporting the uneven weight distribution of a vehicle on the runway surfaces. Although generally small, these changes in the individual runways are sufficient to be reflected in observable changes in various measured pose parameters of an otherwise unchanged vehicle, and accordingly, result either directly or indirectly in changes to the traditional vehicle wheel alignment or vehicle body measurements, such as toe, camber, caster, steering axis inclination (SAI), ride height, center line, thrust line or wheel runout. The amount of change will vary from vehicle to vehicle, and may depend on random factors such as the weight of the vehicle, the position of the vehicle on the individual runways of the vehicle lift rack, etc.

To maintain the degree of accuracy necessary for determining vehicle wheel alignment angles to within accepted tolerances, the changes which occur in the various measured pose parameters for a vehicle following a change in elevation of the vehicle lift rack should be identified and compensated for by the vehicle wheel alignment system. Accordingly, it would be advantageous to provide a method by which changes in various measured pose parameters of a vehicle resulting from changes in elevation of a vehicle supporting lift rack, can be identified, enabling individual traditional vehicle wheel alignment or vehicle body measurements to be correctly compensated for the identified effects.

### BRIEF SUMMARY OF THE INVENTION

Briefly stated, a method of the present disclosure enables a vehicle wheel alignment measurement system to compensate one or more vehicle wheel alignment angle or vehicle body measurements for changes associated with adjustments to an elevation of a pair of vertically movable runways comprising an automotive vehicle lift supporting a vehicle undergoing measurement. An initial set of stable pose measurements are acquired by the vehicle wheel alignment measurement system from the vehicle with the vertically movable runways at a first elevation. Following an elevation change to the vertically movable runways, a second set of stable pose measurements is acquired from the vehicle by the vehicle wheel alignment measurement system. Adjustment factors used to compensate one or more vehicle wheel alignment angles or vehicle body measurements for changes induced by the altered elevation of the automotive vehicle lift configuration are determined by a processing system through comparison of each set of stable pose measurements acquired by vehicle wheel alignment measurement system. Subsequent measurements of the vehicle wheel alignment angles or vehicle body measurements acquired by the vehicle wheel alignment measurement system while the automotive vehicle lift remains at the same elevation are compensated by the adjustment factors to maintain precision and accuracy.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective illustration of a prior art automotive vehicle lift installed in a recessed floor, at a lowered elevation suitable for receiving a vehicle;

FIG. 2 is a perspective illustration of a prior art automotive vehicle scissor-style lift in a raised elevation suitable for carrying out a vehicle measurements, inspections, and adjustments;

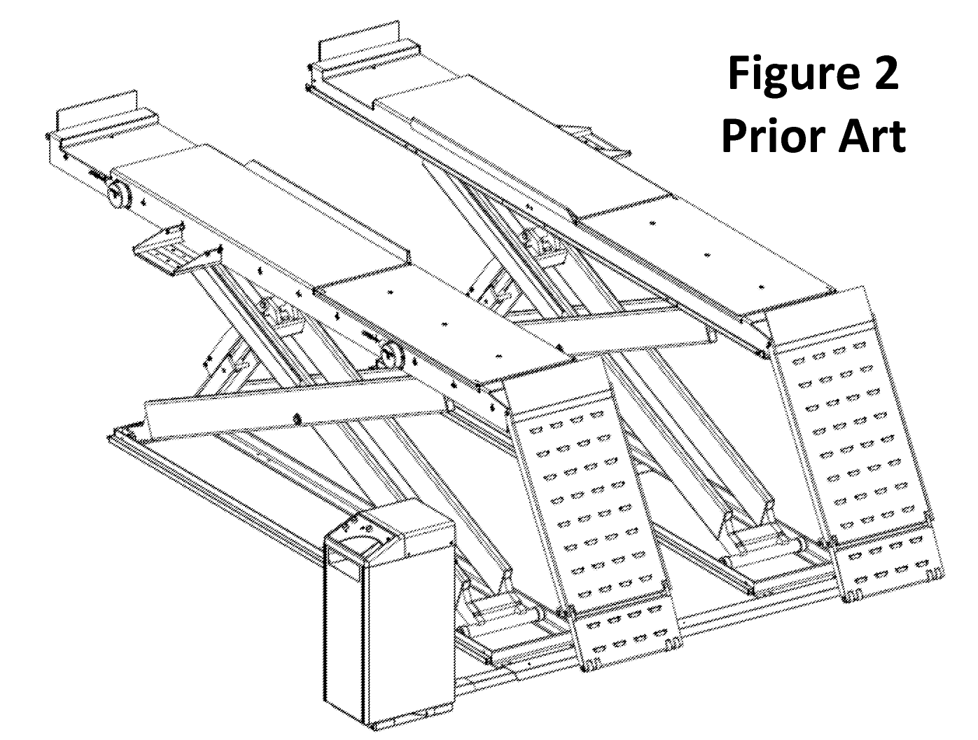

FIG. 3 is a flow chart illustrating the steps of a method of the present disclosure.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

Those of ordinary skill will recognize that while the present disclosure is described in the context of a machine-vision vehicle wheel alignment system, the teachings set forth herein may be utilized with any type of vehicle wheel alignment system capable of acquiring measurements of vehicle wheel alignment angles or vehicle body parameters to compensate acquired measurements for variations resulting from changes in elevation or configuration of a vehicle supporting surface.

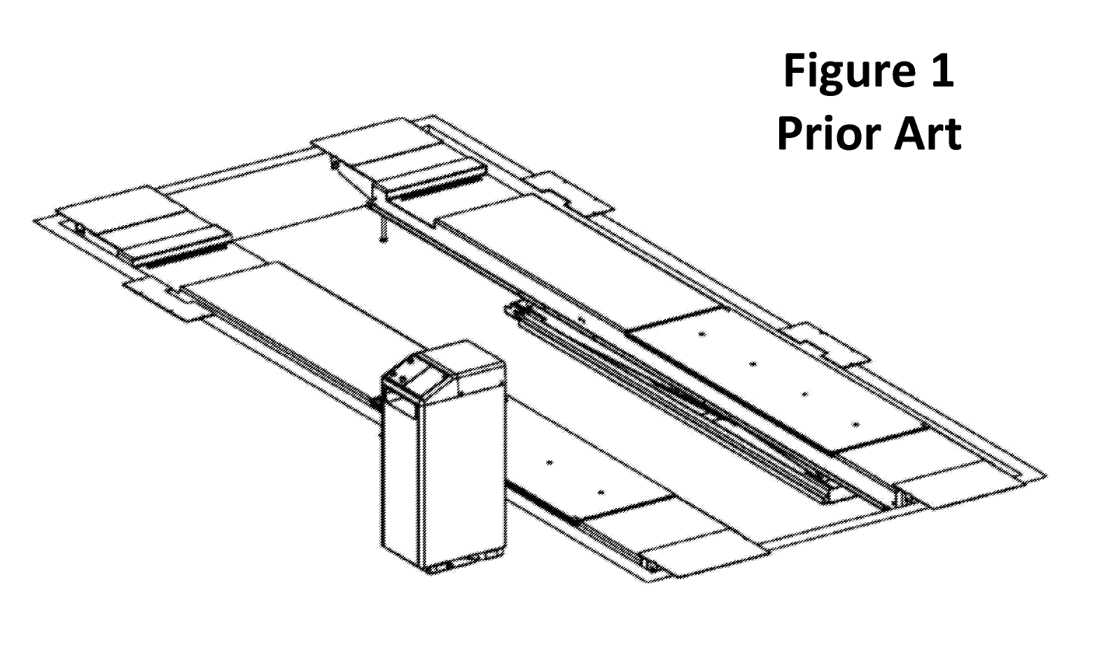

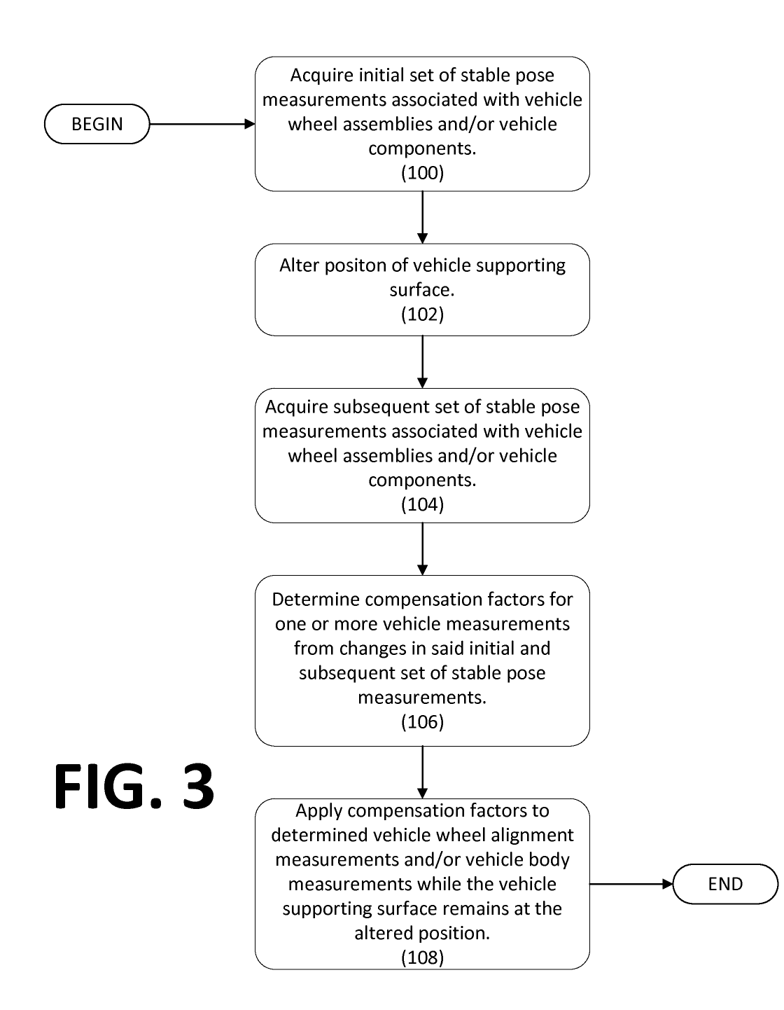

Turning to the figures, and to FIG. 3 in particular, a method of the present disclosure is shown for compensating one or more vehicle wheel alignment angle measurements or vehicle body measurements for deviations introduced by changes in elevation of a vehicle lift supporting the vehicle undergoing measurement. Initially, a set of pose measurements associated with one or more of the vehicle wheel assemblies and/or one or more vehicle components such as the vehicle body, are acquired (Box 100) with the vehicle lift in a first state. Preferably, the initial set of pose measurements are acquired while the vehicle lift surfaces are in a lowered or un-elevated configurations, such as resting on fixed stops or a floor surface as shown in FIG. 1. The initial set of pose measurements may be defined as a set of “home” or “calibration” pose measurements. Those of ordinary skill in the art will recognize that it is further preferable that all pose measurements be acquired only after any transitory movements in the vehicle, vehicle suspension components, or the vehicle lift surfaces have dissipated, and each is in a stable state.

Once the initial set of pose measurements is acquired, the position of the vehicle supporting surface is altered (Box 102) while the vehicle itself remains stationary on the supporting surface, such as by elevating to an alignment adjustment height suitable for a service technician to access the underside of the vehicle, and any resulting transitory movements are allowed to stabilize. With the vehicle supporting surface at a second stable state, a second or subsequent set of the pose measurements associated with the one or more vehicle wheel assemblies and/or one or more vehicle components such as the vehicle body, are acquired (Box 104).

The initial set of pose measurements and the subsequent set of pose measurements are evaluated, such as by comparison, to identify differences or changes. Identified differences or changes between corresponding pose measurements which resulted from the change in the elevation of the vehicle supporting surface are identified and used to directly or indirectly establish compensation factors (Box 106) for individual vehicle wheel alignment angle measurements and vehicle component measurements which are acquired while the vehicle supporting surface remains at the altered position of the vehicle supporting surface (Box 108). These compensated vehicle wheel alignment angle measurements and/or compensated vehicle component measurements may be displayed to an operator in place of, or together with the actual measurements acquired at the altered position of the vehicle supporting surface, effectively correcting for changes introduced to the measurements by variances in the vehicle supporting surface at the altered position. Alternatively, the compensated vehicle wheel alignment angle measurements and/or vehicle component measurements may be stored in an accessible memory system or used in subsequent calculations, such as during a vehicle component adjustment or correction procedure. If the amount of change introduced to the measurements by variances in the vehicle supporting surface at the altered position exceed a selected tolerance, there may exist the possibility of a malfunction, damage, or excessive wear to the vehicle lift mechanisms or supporting surfaces, and a suitable warning is provided to the operator.

Acquisition of the initial and subsequent pose measurements is responsive to either an operator-initiated command, or alternatively, is performed automatically by a vehicle wheel alignment system, such as in response to indications of movement by the vehicle lift system. In a system where the initial and subsequent pose measurements are acquired in response to an operator-initiated command, the vehicle wheel alignment system is configured to receive signals from the operator indicating when the vehicle and vehicle lift system are in suitable states for acquisition of the initial and subsequent sets of pose measurements can be acquired. In the alternatively, the vehicle wheel alignment system is configured to receive a command from the operator to alter the elevation of the vehicle support lift, which in turn triggers the acquisition of an initial set of pose measurements before the vehicle support lift is actuated. Once the movement of the vehicle support lift ceases, either in response to an operator command or the reaching of a pre-set elevation, the vehicle wheel alignment system acquires the subsequent set of pose measurements after a suitable period of delay to permit the structure and vehicle to stabilize at the new elevation.

In yet another alternative configuration, the vehicle wheel alignment system is configured to continuously acquire sets of pose measurements for temporary storage in a queue, and upon the detection of movement in the vehicle support lift, designate one of the previously acquired sets of pose measurements in the queue to be the initial set acquired prior to a start of the movement. A second or subsequent set of pose measurements may be designated from sets of pose measurements which are stored in the queue after a suitable delay period once the vehicle support lift is at the new elevation.

Once a set of compensation factors are established for a position of the vehicle support lift, the individual compensation factors may be stored in an accessible data store for use any time the vehicle support lift is at the associated position during the current vehicle service. Individual compensation factors may be determined and stored in association with multiple positions of the vehicle support lift. If the vehicle support lift is moved during the vehicle service procedure to a different elevation, the associated compensation factors for the new elevation are applied or are calculated as required. If the vehicle support lift is returned to the original or initial position (i.e., lowered to the ground), no compensation factors are used. Due to the variability in weight between different vehicles and the specific positioning of vehicles on the vehicle support lift runways, compensation factors are generally useful only during the current service or measurement of the specific vehicle from which the various pose measurement sets were acquired.

Preferably, the use of determined compensation factors by the vehicle wheel alignment measurement system is transparent to the operator. For example, if a set of measurements is obtained for the toe, camber, and caster angles of a vehicle on a vehicle support lift at ground level, the application of compensation factors by the vehicle wheel alignment system enables the same measured values to be displayed to the operator when the vehicle support lift is elevated to an alignment height, even if one or more of the angles on the vehicle has changed due to a distortion in a runway of the vehicle support lift at the elevated height.

The present disclosure can be embodied in-part in the form of computer-implemented processes and apparatuses for practicing those processes. The present disclosure can also be embodied in-part in the form of computer program code containing instructions embodied in tangible media, or another computer readable non-transitory storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a non-transitory storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A method for compensating at least one measurement of a vehicle for deviations resulting from a change in elevation of a vehicle lift system support surface on which the vehicle is disposed, comprising:
acquiring a first set of stable pose measurements associated with the vehicle while the vehicle is disposed on the support surface at a first elevation;
altering the elevation of the support surface without moving the vehicle relative to the support surface;
acquiring a second set of stable pose measurements associated with the vehicle while the support surface is at said altered elevation;
evaluating said first and second sets of stable pose measurement to establish a compensation factor for the at least one vehicle measurement; and
establishing at least one corrected vehicle measurement by applying said compensation factor to the at least one vehicle measurement.

2. The method of claim 1 wherein said at least one vehicle measurement is a vehicle wheel alignment angle.

3. The method of claim 1 wherein said at least one vehicle measurement is a vehicle component measurement.

4. The method of claim 1 wherein said at least one vehicle measurement is a vehicle ride height measurement.

5. The method of claim 1 wherein said first and second sets of stable pose measurements are each acquired in response to an operator-initiated command.

6. The method of claim 1 wherein said first and second sets of stable pose measurements are each acquired automatically in response to receipt of a command to alter said elevation of the support surface.

7. The method of claim 1 wherein said first and second sets of stable pose measurements are each selected from a continuously updated queue of periodically acquired sets of pose measurements.

8. The method of claim 7 wherein said second set of stable pose measurements is selected from said queue after a delay period once the vehicle support surface is at said altered elevation.

9. The method of claim 1 wherein evaluating said first and second sets of stable pose measurements further identifies a change in a pose of said vehicle associated with said change in elevation, said change in said vehicle pose representative of an operating condition of said vehicle lift system; and
generating a signal in response to said change in said vehicle pose exceeding a tolerance associated with said vehicle lift system.

10. The method of claim 1 further including the step of generating a warning to an operator responsive to said compensation factor exceeding a tolerance.

11. A vehicle wheel alignment measurement system for use with a vehicle lift system, comprising:
a set of measurement sensors for acquiring pose measurements associated with a vehicle disposed on a support surface of said vehicle lift system;
a processing system operatively configured to receive said acquired pose measurements from said set of measurement sensors, said processing system configured with software instructions to determine at least one vehicle measurement, and a compensation factor for said at least one vehicle measurement from deviations between an initial set of pose measurements acquired with the support surface of said vehicle lift system at an initial stable position and a second set of pose measurements acquired with the support surface of said vehicle lift system at an altered stable position; and
wherein said processing system is further configured to calculate at least one corrected vehicle measurement by applying said determined compensation factor to at least one vehicle measurement acquired while said support surface is disposed at said altered stable position.

12. The vehicle wheel alignment measurement system of claim 11 wherein said at least one vehicle measurement is a vehicle wheel alignment angle.

13. The vehicle wheel alignment measurement system of claim 11 wherein said at least one vehicle measurement is a vehicle component measurement.

14. The vehicle wheel alignment measurement system of claim 11 wherein said at least one vehicle measurement is a vehicle ride height measurement.

15. The vehicle wheel alignment measurement system of claim 11 wherein said initial set of pose measurements and said second set of pose measurements each represent measures of the same data points.

16. The vehicle wheel alignment measurement system of claim 11 wherein said processing system is further configured to generate a warning to an operator if said compensation factor exceeds a tolerance.

17. The vehicle wheel alignment measurement system of claim 11 wherein said processing system is operatively coupled to a user interface, and wherein said processing system is further configured to present said at least one corrected vehicle measurement to an operator through said user interface.

18. The vehicle wheel alignment measurement system of claim 11 wherein said processing system is configured to evaluate said initial and second sets of pose measurements to identify a change in a pose of said vehicle associated with said change in elevation, said change in said vehicle pose representative of an operating condition of said vehicle lift system; and
wherein said processing system is further configured to generate a signal in response to said identified change in said vehicle pose exceeding a tolerance associated with said vehicle lift system.

19. A vehicle wheel alignment measurement system for use with a vehicle lift system, comprising:
a set of optical sensors for observing optical targets associated with a vehicle disposed on a support surface of said vehicle lift system;
a processing system operatively configured to receive images of said observed optical targets from said set of optical sensors, said processing system configured with software instructions to evaluate said received images to determine at least one vehicle wheel alignment angle measurement;
wherein said processing system is further configured to determine a compensation factor for said at least one vehicle wheel alignment angle measurement from deviations between an initial measurement of said wheel alignment angle determined from images of said observed optical targets received when the support surface of said vehicle lift system is at a first stable position, and a second measurement of said wheel alignment angle determined from images of said observed optical targets received when the support surface of said vehicle lift system is at an altered stable position; and
wherein said processing system is further configured to calculate at least one corrected vehicle wheel alignment measurement by applying said determined compensation factor to at least one vehicle wheel alignment measurement acquired while said support surface is disposed at said altered stable position.
